(19) United States
(12) Patent Application Publication
(10) Pub. No.: US 2024/0362646 A1
(43) Pub. Date: Oct. 31, 2024

(54) ZERO-TRUST DIGITAL WALLET (BLOCKCHAIN) WITH SMART CONTRACTS

(71) Applicant: Dell Products L.P., Round Rock, TX (US)

(72) Inventors: Ofir Ezrielev, Be’er Sheba (IL); Yehiel Zohar, Sderot (IL); Lee Serfaty, Be’er Sheba (IL)

(21) Appl. No.: 18/307,993

(22) Filed: Apr. 27, 2023

(51) Int. Cl. G06Q 20/40; G06Q 20/10; G06Q 20/36; G06Q 20/38

(52) U.S. Cl. CPC G06Q 20/405; G06Q 20/10; G06Q 20/36; G06Q 20/3829; G06Q 2220/00

(57) ABSTRACT

A digital wallet is provided with zero-trust security. A digital wallet implemented in a blockchain may store a digital asset. The digital asset is associated with a smart contract. When a transaction is received, the smart contract is triggered to determine whether the transaction is authorized. If the transaction is authorized, the transaction is performed. If the transaction is unauthorized, a protection action, which may include transferring the digital asset to a different digital wallet, is performed.

### FIELD OF THE INVENTION

Embodiments of the present invention generally relate to blockchain networks. More particularly, at least some embodiments of the invention relate to systems, hardware, software, computer-readable media, and methods for a zero-trust digital wallet.

### BACKGROUND

Generally stated, blockchain technology is a technology that allows data to be stored in blocks that are linked together. Blockchain technology can be used for various purposes including, by way of example, energy, finance, media, entertainment, and retail purposes. A well-known use of a blockchain network is to store digital assets. Blockchain networks allows the assets and transactions related to the assets to be recorded and tracked.

A blockchain network may have certain features. For example, blockchain networks are often decentralized. As a result, a single individual or a single entity does not have total control of the blockchain network or unilateral decision-making capabilities. Further, blockchain networks are transparent such that users can have confidence in the data stored in the blockchain network and in changes made to data stored in the blockchain network. Members of a blockchain network can trust the blockchain network because the data is shared to all members of the blockchain network and all transactions relative to the data are stored in the blockchain network and visible to the members.

Blockchain networks are also immutable. Consequently, no user can tamper with a transaction once the transaction has been recorded in the blockchain network. In order to change a transaction, it is necessary to add the change to the blockchain network such that the data and all changes or transactions are visible.

Even though blockchains provide immutability and transparency, the ability to use and access the data or to perform transactions often depends on the use of a private cryptographic key. The control of a user over the data in the blockchain network may be compromised if the user's private key is compromised.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a blockchain network;

FIG. 2 discloses aspects of a blockchain network with aspects of zero-trust security;

FIG. 3 discloses aspects of zero-trust security in digital wallets;

FIG. 4 discloses aspects of a method for zero-trust security in blockchain network; and

FIG. 5 discloses aspects of a computing device, a computing system, or a computing entity.

### DETAILED DESCRIPTION OF SOME EXAMPLE EMBODIMENTS

Embodiments of the present invention generally relate to blockchain networks and smart contracts. More particularly, at least some embodiments of the invention relate to systems, hardware, software, computer-readable media, and methods for a zero-trust digital wallet in a blockchain network.

In general, example embodiments of the invention relate to blockchain network operations, digital wallet operations, smart contract operations, zero-trust operations, asset protection operations, asset transfer operations, and the like or combinations thereof.

Blockchain networks (or blockchains) can be used to store and track information of any kind such as medical records, financial records, confidential information, digital assets, school records, business transactions, online payments, cryptocurrencies, or the like. Embodiments of the invention are discussed in the context of digital assets but may be adapted to other data. Examples of digital assets include, but are not limited to, anything that is stored digitally and has value to an organization. Thus, data such as documents, audio, videos, logos, websites, code, and other data are examples of digital assets. Digital assets also include nonfungible tokens, cryptocurrency, security tokens, digital currencies, or the like.

A blockchain, which may also be referred to as a distributed ledger or a distributed database, may have many different uses and store different types of information or data. A common use of blockchain technology is to use the blockchain as a ledger for transactions.

Blockchains often store information in blocks that are usually related to each other cryptographically and chronologically. When new data or information is added to a blockchain or when a transaction is performed relative to a digital asset, a new block may be created, filled with the relevant data or information, and chained or added to the blockchain. If there is a need to change data in an existing block, the change is usually reflected in a new block because existing blocks are immutable.

In fact, the immutability of blockchains is one of its advantages. Blockchains are usually implemented in a decentralized manner such that no individual user or group has control of the blockchain. The decentralized nature of a blockchain supports its immutability. For example, data or information, once entered into the blockchain, cannot be removed from the blockchain. Consequently, transactions are permanently recorded and viewable to anyone with access to the blockchain.

Blockchains also have disadvantages. While the irrevocability and immutability of a transaction is often viewed as a benefit, the irrevocability of a transaction can also be viewed as a disadvantage. For example, an attacker may acquire the private key (or password) of a user and use that key or password to perform a transaction, such as transferring digital assets away from the owner to a different account or wallet. This type of transaction is irreversible and may result in loss to the original owner.

Embodiments of the invention improve the security of a blockchain by adding zero-trust capabilities. In one example, a digital asset stored in a blockchain is associated with a script or a smart contract. The smart contract may be configured to execute an action (a transaction in the blockchain) when certain conditions are satisfied. A smart contract may be configured to perform protective actions relative to a digital asset. For example, the smart contract may indicate that a digital asset can only be transferred to account X and also indicate that if a request or order arrives that is not specifically listed in the smart contract as permitted or allowed, the smart contract may transfer the digital asset to a different account or wallet that may also be specified in the smart contract. The smart contract may specify different types of rules. For example, the smart contract may specify a maximum amount that can be transferred within a time frame, limit the amount transferred to accounts not specifically specified in the smart contract, limit the amount transferred to a single other wallet, or the like.

If an order or transaction is received at a blockchain (e.g., a digital wallet) that is not specifically allowed by the smart contract or that violates another rule specified in the smart contract, it is possible to assume that the private key of the user has been compromised. Using a smart contract allows the user or owner to protect their digital asset in the event their private key is compromised (e.g., stolen) and used in an unauthorized manner by moving the digital asset to a different location in the blockchain (or a different blockchain). Transactions that violate the rules or that are not permitted by the smart contract are cancelled, not performed, reported, or the like. More specifically, the digital asset may be transferred to a situation where it is associated with a different private key. For example, a digital asset may be transferred from the existing digital wallet to a new digital wallet.

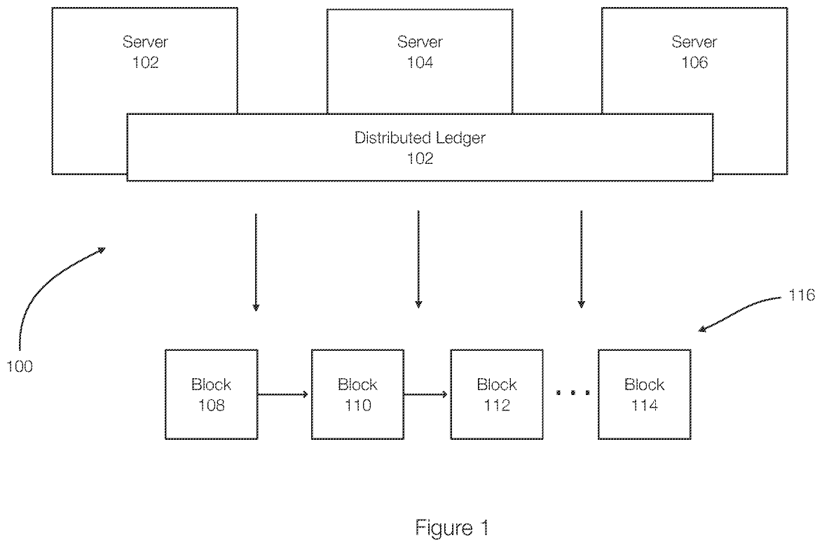

FIG. 1 discloses aspects of a blockchain. The blockchain 100 is discussed in the context of digital assets. In this example, the blockchain 100 is implemented as a digital ledger 102 in which transactions relative to digital assets are recorded. The ledger 102 is distributed across multiple computing devices, represented by servers 102, 104, and 106. In one example, the distributed ledger 102 is implemented in a peer-to-peer network.

The ledger 102 includes a chain of blocks 116. The blocks 116 in the blockchain 100 or the ledger 102 are represented by blocks 108, 110, 112, and 114. These blocks are linked cryptographically and chronologically. Each time a new block is added, the block is added to the end of the blockchain in one example. As transactions are performed, blocks are added to the blockchain 100.

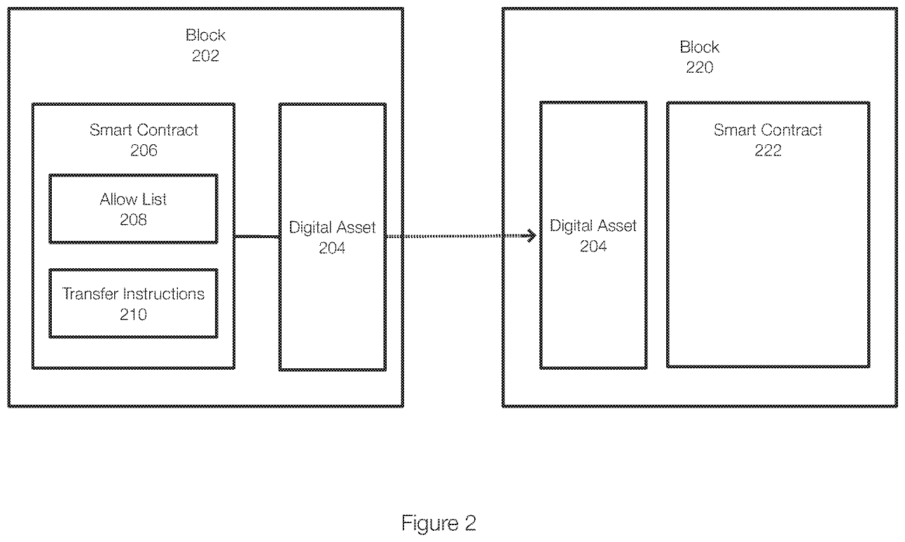

FIG. 2 discloses aspects of implementing zero-trust capabilities in a blockchain. FIG. 2 illustrates a block 202 that includes data. The data includes a digital asset 204 and a smart contract 206. The smart contract 206 further includes or implements an allow list 208 and transfer instructions 210. In this example, the allow list 208 specifies actions or transactions that are allowed with respect to the digital asset 204. The allow list 208 may specify other transactions that are permitted or not permitted or express other rules related to the digital asset 204. If a request is received by the blockchain related to the digital asset 204 is not in the allow list 208, the transfer instructions 210 are invoked and the request is denied or thwarted.

In this example, the transfer instructions 210 transfer the digital asset 204 to the block 220, which may be associated with a new smart contract 222. More specifically in one example, the digital asset 204 is transferred to a different digital wallet, which may be partially represented by the block 220.

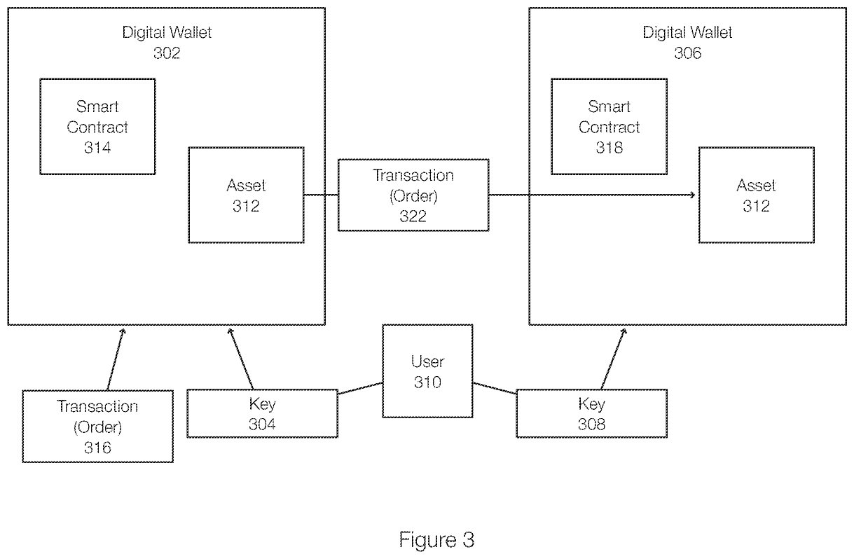

FIG. 3 illustrates an example of transferring a digital asset from a current digital wallet to a different digital wallet. FIG. 3 illustrates a digital wallet 302 and a digital wallet 306 that are implemented, in one example, using blockchain technologies. In one example, a digital wallet, such as the digital wallet 302, may include addresses and digital keys. The digital wallet 302 is configured to enable access to the digital assets stored in the blockchain.

In this example, the digital wallet 302 and the digital wallet 306 are both associated with a user 310. In this example, the digital wallet 302 is associated with a key 304 and the digital wallet 306 is associated with a key 308. The keys 304 and 308 are associated with different wallets and are separated. Thus, the key 308 is not compromised if the key 304 is compromised. The keys 304 and 308 may be private keys that are associated with corresponding public keys.

More specifically, a digital wallet 302 may be associated with both a private key and a public key. The private key may be, for example, an alphanumeric code that may be used for cryptographical purposes. The digital wallet 302 may be a set of public addresses and private keys. Anyone can deposit a digital asset to a public address using the public key. However, digital assets generally cannot be removed from an address without the appropriate private key.

It is important to safeguard the key 304 (the private key). When a transaction from the digital wallet 302 is initiated, a digital signature is created by processing the transaction with the key 304. Once the transaction is authorized and broadcast or recorded in the blockchain, the transaction cannot be changed. Consequently, the asset 312 is at risk if the key 304 is obtained by another user or is compromised in other ways.

The keys 304 and 308 should be kept private and secure. For, the keys 304 and 308 may be kept in storage that is not accessible to hackers until needed. The keys 304 and 308 are generally stored in different locations or storage repositories such that if an attacker compromises the key 304, the key 308 is not affected. However, keys may also be kept in custodial wallets. A custodial wallet may be a service provided by another entity that relieves the user of storing their keys. However, there is an increased risk that the keys will be compromised. If the key 304 is stolen or compromised by an attacker, the attacker may attempt to perform a transaction on the asset 312. The attacker, for example, may attempt to transfer the asset 312 to another wallet that is not associated with the user 310.

In this example, the asset 312 is associated with a smart contract 314 that specifies allowed or authorized transactions and that specifies protective actions to perform in the event an unallowed or unauthorized transaction is received at an address of the digital wallet 302.

In FIG. 3, an order or transaction 316 is received at the digital wallet 302 to withdraw the asset 312 to another public address or to another digital wallet. Prior to performing the transaction 316, the transaction is evaluated or processed by the smart contract 314. More specifically, the smart contract 314 is triggered by the receipt of the transaction 316. This helps protect the asset 312 in the event that the transaction 316 is fraudulent.

In this example, the public address or destination specified in the transaction 316 is not a permitted destination. In other words, the transaction 316 is not included in the allowed list of the smart contract 314. As a result, the smart contract 314 cancels the transaction 316 and initiates another transaction 322 to transfer the asset 312 to another digital wallet 306, which is associated with a different key 308. The smart contract 314 thus provides a zero-trust mechanism to protect the asset 312 from transactions or orders that are not specifically permitted.

In another example, the user 310 may be able to alter or update the smart contract 314. For example, the user 310 may desire to remove an allowed transaction (e.g., public address) and add a new allowed transaction. Because the smart contract 314 is written to the blockchain, the smart contract 314 is immutable and cannot be changed. However, the smart contract 314 may allow the asset 312 to be migrated to a new instance of the smart contract, which is illustrated as the smart contract 318. In another example, the smart contract 314 may include a function call to code that is not included in the blockchain. This allows the code outside of the blockchain to be modified by the user as necessary. Thus, the smart contract 314 may simply ensure that transaction should be verified in the context of an allow list that is not included in the blockchain. This allows the user 310 to modify the allow list as desired. In another example, the allow list may be in the blockchain and be controlled by another key. This allows the allow list to be changed using the appropriate key to transfer/alter the allow list by adding a transaction or block to the blockchain.

In one example, the smart contract 314 may require the transaction 316 to be evaluated in the context of an allow list that is outside of the blockchain. This allows the user to alter the allow list as needed while still protecting the asset 312 frum unauthorized orders or transactions. The allow list may also be stored in the blockchain and may be changed by migrating the allow list to a new block that is associated with a different smart contract.

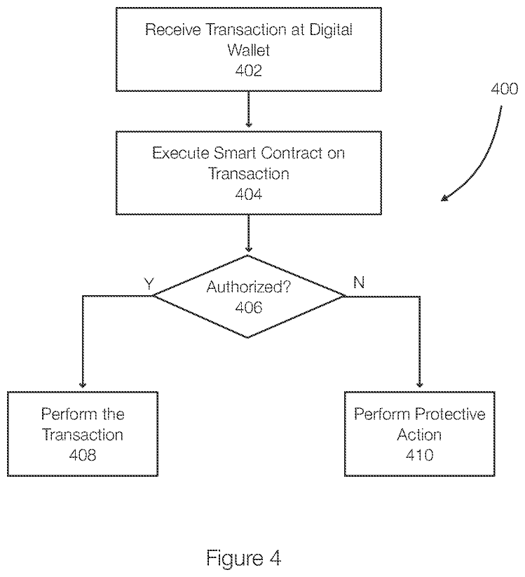

FIG. 4 discloses aspects of a method for protecting digital assets or for implementing aspects of zero-trust security in blockchain networks. The method 400 includes receiving 402 a transaction at a digital wallet (e.g., at a public address or at the blockchain network). The transaction may relate to an action to be performed on a digital asset. For example, the transaction may be to transfer the digital asset to another digital wallet. In this example, the transaction may appear to be valid because the appropriate private key was used in the transaction.

When the transaction is received, a smart contract associated with the digital asset is executed 404 on the transaction. If the transaction is authorized (Y at 406), the order is performed. If the transaction is not authorized (N at 406), a protective action is performed 410.

Executing 404 the smart contract may include determining whether the order is allowed or unauthorized based on an allowed list. If the only orders or transactions that can be performed on the digital assets are specified in the allow list and the order specifies an action or a transaction that is not on the allowed list, the order will be rejected and a protective action 410 is performed. The protective action may include transferring the digital asset to another digital wallet. By transferring the digital asset to another digital wallet, the digital wallet is protected from the threat of the unauthorized order. Further, the unauthorized transaction cannot be performed because the digital asset is no longer present in the digital wallet.

When the transaction is determined to be unauthorized, alerting operations in addition, which are also examples of protection operations, may be performed. The owner of the digital wallet, for example, may be notified of the unauthorized transaction. The notification method may be specified in the smart contract.

Embodiments of the invention thus allow security to be provided to digital wallets in various situations where a user's private key is compromised.

Embodiments of the invention are generally described in the context of transactions that are allowed or not allowed. However, a smart contract may also be implemented in the context of performing commands on assets. For example, a smart contract generator may be a trusted asset. Causing the smart contract generator to generate a smart contract by command. This may allow smart contracts to be generated, for example, during execution of a smart contract. A smart contract may include a command to generate a new smart contract. When a digital asset is transferred to a different digital wallet, a command executed on a digital asset may allow the transferred asset to be associated with a smart contract. In addition, embodiments of the invention may contemplate blockchains or distributed ledgers where the digital assets themselves can be modified, but transactions related to the digital assets cannot be modified.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, blockchain operations, smart contract operations, data asset protection operations, or the like. More generally, the scope of the invention embraces any operating environment in which the disclosed concepts may be useful.

New and/or modified data collected and/or generated in connection with some embodiments, may be stored in a data or storage environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data related functionality. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing. The term data may also refer to digital assets or other types of objects or information capable of being stored in blockchain networks.

It is noted that any operation(s) of any of the methods disclosed herein including the Figures, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a transaction at a digital wallet, executing a smart contract in response to receiving the transaction, wherein the smart contract implements zero-trust security for a digital asset stored in the digital wallet, determining that the transaction is authorized or unauthorized, and performing a protective action when the transaction is unauthorized and performing the transaction when the transaction is authorized.

Embodiment 2. The method of embodiment 1, further comprising generating the smart contract to be associated with the digital asset.

Embodiment 3. The method of embodiment 1 and/or 2, wherein the smart contract comprises an allow list that specifies allowed transactions, wherein the transaction is authorized when the transaction is included in the allow list.

Embodiment 4. The method of embodiment 1, 2, and/or 3, further comprising including the allow list in the smart contract.

Embodiment 5. The method of embodiment 1, 2, 3, and/or 4, wherein the allow list is outside of the digital wallet and not included in a blockchain associated with the digital wallet.

Embodiment 6. The method of embodiment 1, 2, 3, 4, and/or 5, wherein the protective action includes transferring the digital asset to a second digital wallet.

Embodiment 7. The method of embodiment 1, 2, 3, 4, 5, and/or 6, wherein the second digital wallet is owned by an owner of the digital wallet and wherein the second digital wallet is associated with a private key different from a private key associated with the digital wallet.

Embodiment 8. The method of embodiment 1, 2, 3, 4, 5, 6, and/or 7, wherein the protective action includes associating the digital asset transferred to the second digital wallet with a second smart contract that includes an allow list.

Embodiment 9. The method of embodiment 1, 2, 3, 4, 5, 6, 7, and/or 8, further comprising notifying an owner of the digital wallet that the digital asset has been transferred to a second digital wallet and that an unauthorized transaction was received.

Embodiment 10. The method of embodiment 1, 2, 3, 4, 5, 6, 7, 8, and/or 9, further comprising requiring a key different from a key associated with the digital wallet or a verification method to effect changes to the smart contract.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, client, or service may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

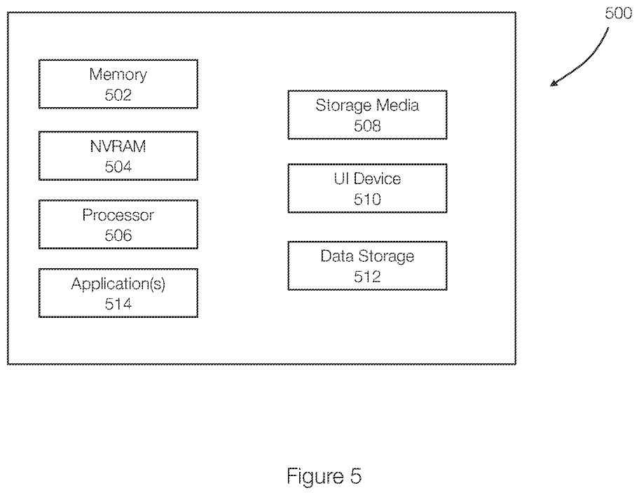

With reference briefly now to FIG. 5, any one or more of the entities disclosed, or implied, herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a transaction at a digital wallet;
executing a smart contract in response to receiving the transaction, wherein the smart contract implements zero-trust security for a digital asset stored in the digital wallet;
determining that the transaction is authorized or unauthorized; and
performing a protective action when the transaction is unauthorized and performing the transaction when the transaction is authorized.

2. The method of claim 1, further comprising generating the smart contract to be associated with the digital asset.

3. The method of claim 1, wherein the smart contract comprises an allow list that specifies allowed transactions, wherein the transaction is authorized when the transaction is included in the allow list.

4. The method of claim 3, further comprising including the allow list in the smart contract.

5. The method of claim 3, wherein the allow list is outside of the digital wallet and not included in a blockchain associated with the digital wallet.

6. The method of claim 3, wherein the protective action includes transferring the digital asset to a second digital wallet.

7. The method of claim 6, wherein the second digital wallet is owned by an owner of the digital wallet and wherein the second digital wallet is associated with a private key different from a private key associated with the digital wallet.

8. The method of claim 6, wherein the protective action includes associating the digital asset transferred to the second digital wallet with a second smart contract that includes an allow list.

9. The method of claim 1, further comprising notifying an owner of the digital wallet that the digital asset has been transferred to a second digital wallet and that an unauthorized transaction was received.

10. The method of claim 1, further comprising requiring a key different from a key associated with the digital wallet or a verification method to effect changes to the smart contract.

11. A non-transitory storage medium having stored therein instructions that are executable by one or more hardware processors to perform operations comprising:
receiving a transaction at a digital wallet;
executing a smart contract in response to receiving the transaction, wherein the smart contract implements zero-trust security for a digital asset stored in the digital wallet;
determining that the transaction is authorized or unauthorized; and
performing a protective action when the transaction is unauthorized and performing the transaction when the transaction is authorized.

12. The non-transitory storage medium of claim 11, further comprising generating the smart contract to be associated with the digital asset.

13. The non-transitory storage medium of claim 11, wherein the smart contract comprises an allow list that specifies allowed transactions, wherein the transaction is authorized when the transaction is included in the allow list.

14. The non-transitory storage medium of claim 13, further comprising including the allow list in the smart contract.

15. The non-transitory storage medium of claim 13, wherein the allow list is outside of the digital wallet and not included in a blockchain associated with the digital wallet.

16. The non-transitory storage medium of claim 13, wherein the protective action includes transferring the digital asset to a second digital wallet.

17. The non-transitory storage medium of claim 16, wherein the second digital wallet is owned by an owner of the digital wallet and wherein the second digital wallet is associated with a private key different from a private key associated with the digital wallet.

18. The non-transitory storage medium of claim 16, wherein the protective action includes associating the digital asset transferred to the second digital wallet with a second smart contract that includes an allow list.

19. The non-transitory storage medium of claim 11, further comprising notifying an owner of the digital wallet that the digital asset has been transferred to a second digital wallet and that an unauthorized transaction was received.

20. The non-transitory storage medium of claim 11, further comprising requiring a key different from a key associated with the digital wallet or a verification method to effect changes to the smart contract.
